(19) United States
(12) Patent Application Publication
(10) Pub. No.: US 2026/0339418 A1
(43) Pub. Date: Oct. 29, 2026

(54) MODULATING POWER USAGE WHILE USING A COMPANION DEVICE

(71) Applicant: Apple Inc., Cupertino, CA (US)

(72) Inventors: Rahul NAIR, Hayward, CA (US); Devin W. CHALMERS, Oakland, CA (US); Luis R. DELIZ CENTENO, Fremont, CA (US)

(21) Appl. No.: 19/640,170

(22) Filed: Apr. 6, 2026

Related U.S. Application Data
(60) Provisional application No. 63/794,167, filed on Apr. 24, 2025.

(51) Int. Cl. G06F 1/3234; G09G 5/00

(52) U.S. Cl. CPC G06F 1/3265; G09G 5/003; G09G 2330/021

(57) ABSTRACT

Some examples of the disclosure are directed to systems and methods for modulating power usage while using a companion device. In some examples, a display device is in communication with a companion device. The companion device causes the display device to display content on the one or more displays of the display device. In some examples, the companion device obtains data using one or more input devices to determine if one or more first criteria are satisfied. Based on the data, the companion device displays content on the display device in a first manner or in a second manner. In some examples, the first manner is associated with a high power mode and the second manner is associated with a low power mode. In some examples, selectively activating a high power mode based on input data allows the electronic device to preserve power and improve power and thermal performances.

### CROSS-REFERENCE TO RELATED APPLICATIONS

This application claims the benefit of U.S. Provisional Application No. 63/794,167, filed Apr. 24, 2025, the content of which is herein incorporated by reference in its entirety for all purposes.

### FIELD OF THE DISCLOSURE

This relates generally to systems and methods of modulating power usage while using a companion device.

### BACKGROUND OF THE DISCLOSURE

Some computer graphical environments provide two-dimensional and/or three-dimensional environments where at least some objects displayed for a user's viewing are virtual and generated by a computer. In some examples, the electronic device is in communication with one or more displays which display computer graphical environments. Displaying computer graphical environments requires power usage from the electronic device.

### SUMMARY OF THE DISCLOSURE

Some examples of the disclosure are directed to systems and methods for modulating power usage while using a companion device. In some examples, a display device is in communication with a companion device. The companion device causes the display device to display content on the one or more displays of the display device. In some examples, the companion device obtains data using one or more input devices to determine if one or more first criteria are satisfied. Based on the data, the companion device displays content on the display device in a first manner or in a second manner. In some examples, the first manner is associated with a high power mode and the second manner is associated with a low power mode. In some examples, selectively activating a high power mode based on input data allows the electronic device to preserve power and improve power and thermal performances.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3H illustrate an example where an electronic device transitions between different power states based on information gathered from one or more input devices according to some examples of the disclosure.

FIG. 4 illustrates a flow diagram illustrating an example process for transitioning between different power states based on information gathered from one or more input devices according to some examples of the disclosure.

### DETAILED DESCRIPTION

Some examples of the disclosure are directed to systems and methods for modulating power usage while using a companion device. In some examples, a display device is in communication with a companion device. The companion device causes the display device to display content on the one or more displays of the display device. In some examples, the companion device obtains data using one or more input devices to determine if one or more first criteria are satisfied. Based on the data, the companion device displays content on the display device in a first manner or in a second manner. In some examples, the first manner is associated with a high power mode and the second manner is associated with a low power mode. In some examples, selectively activating a high power mode based on input data allows the electronic device to preserve power and improve power and thermal performances.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

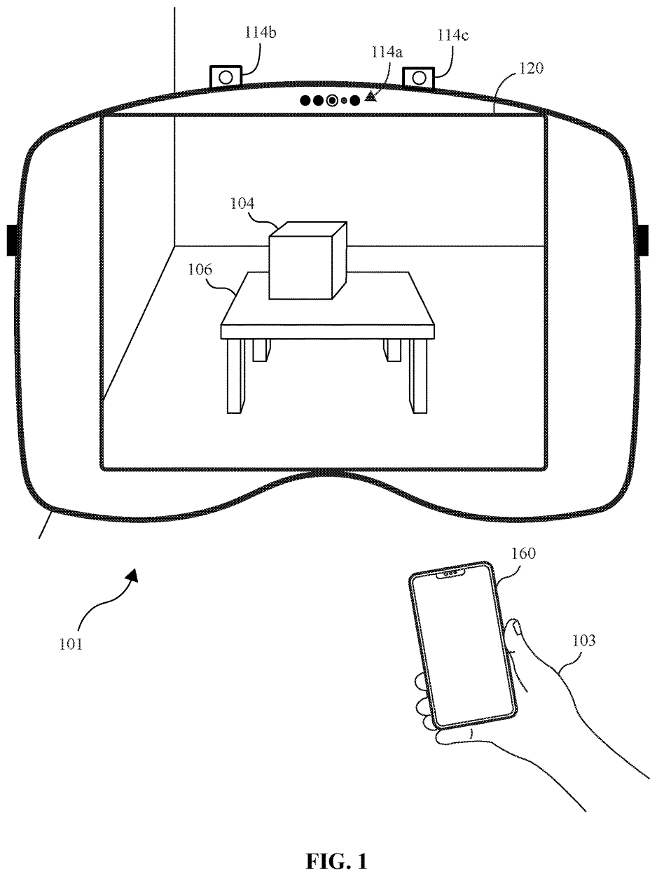

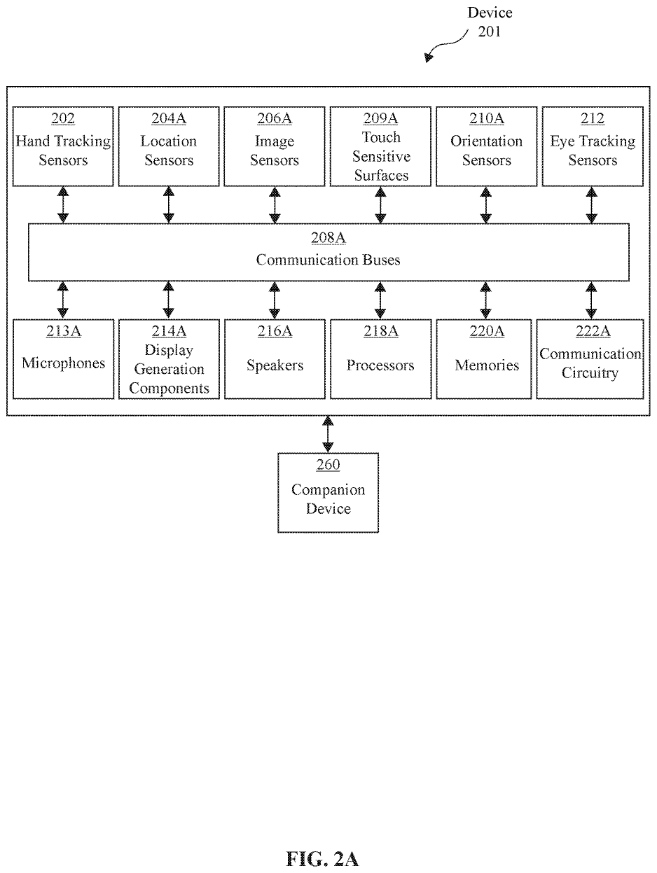

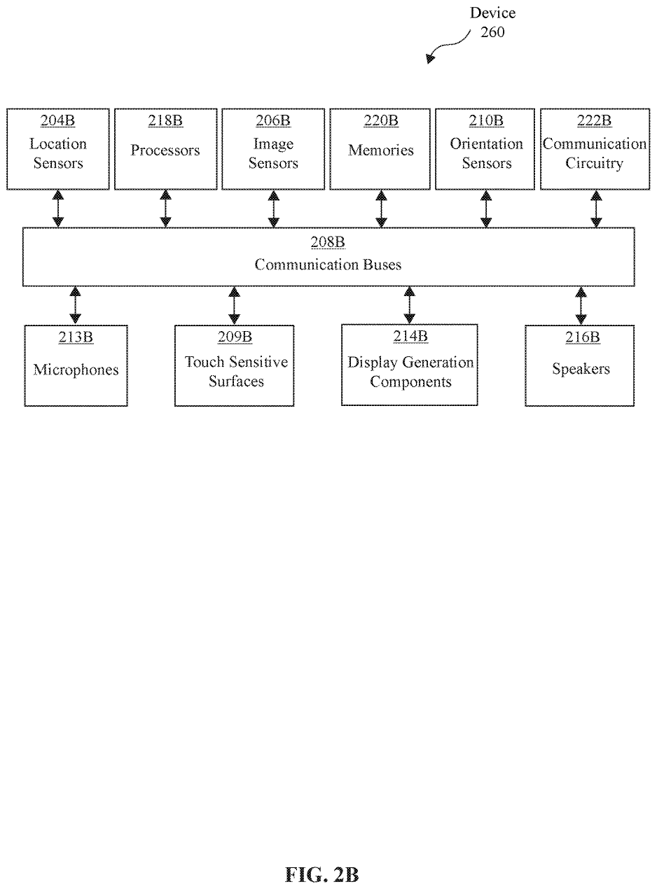

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays. In FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards interactions with one or more virtual objects that are displayed in a three-dimensional environment presented at a first electronic device (e.g., corresponding to electronic device 201). The first electronic device is in communication with a second electronic device which determines a power state of the first electronic device and the second electronic device based on the context of what is being displayed and data from one or more input devices. In some examples, the second electronic device operates according to a high power state or a low power state. In some examples, switching to a low power state when high power is not needed advantageously allows the second electronic device to modulate power consumption and extend battery life (e.g., by using less processing power while in a low power state).

In some examples, the first electronic device (e.g., electronic device 201 above) is in communication with a companion device (e.g., companion device 260 and the second electronic device described above), as described in FIGS. 2A-2B. In some examples, the first electronic device is and/or includes one or more displays that rely on the second electronic device (e.g., the companion device) to display content. In some examples, the second electronic device is a wearable device with one or more output devices (e.g., a display and/or speakers) and one or more input devices (e.g., one or more sensors described above). In some examples, the first electronic device also includes one or more sensors to gather data to determine the power state of the second electronic device.

While in the high power mode or state, the first electronic device includes and/or operates according to one or more of the following power functions: world locking, body locking, face tracking, a high content refresh rate and/or a high render rate. While in the high power mode, the second electronic device displays content on the first electronic device at a first size. While in the high power mode, the first electronic device includes and/or displays content at a first brightness, a first frame rate, and/or a first persistence level. While in the high power mode, the second electronic device maintains a first reprojection rate below a threshold reprojection rate (e.g., 25% reprojection, 50% reprojection, or 75% reprojection). In some examples, the reprojection rate is the percentage of frames that are not rendered by the graphics processing unit (GPU) of the second electronic device but instead are generated by software, using motion data and previous frames, to maintain a smooth and consistent visual experience, even when the GPU is unable to keep up with the content refresh rate of the display. In some examples, the second electronic device transitions to the low power mode or state when one or more criteria to transition to a high power mode are not satisfied. While in the low power mode, the first electronic device includes and/or operates according to one or more of the following power functions: body locking, head locking, a lower content refresh rate, and/or a lower render rate. While in the low power mode, the second electronic device displays content on the first electronic device at a second size, smaller than the first size. While in the low power mode, the first electronic device includes and/or displays content at a second brightness, lower than the first brightness, a second frame rate, lower than the first frame rate, and/or a second persistence level higher than the first persistence level. While in the low power mode, the second electronic device maintains a second reprojection rate that is above the threshold reprojection rate. These power functions are described in greater detail below. Head locking and body locking are described in greater detail above.

In some examples, world locking and body locking require more processing power and therefore more battery usage than head locking. For example, world locking or body locking requires approximately 90 frames per second (fps) while head locking requires approximately between 45 to 60 fps. In some examples, a content refresh rate refers to how many times a display (e.g., a display of the first electronic device) updates the display of content per second. In some examples, a render rate refers to how many frames the second electronic device can process and display per second. In some examples, face tracking includes tracking one or more of the user's face movements, such as eye tracking and/or head tracking. In some examples, while in the high power mode, the second electronic device may perform face tracking more frequently than in the low power mode (e.g., 400 Hz in the high power mode vs. 100 Hz in the low power mode). In some examples, face tracking is used to perform body locking. For example, while in the high power mode, the second electronic device performs face tracking to determine where the user is looking and cause the electronic device 101 to display content relative to the user's positioning.

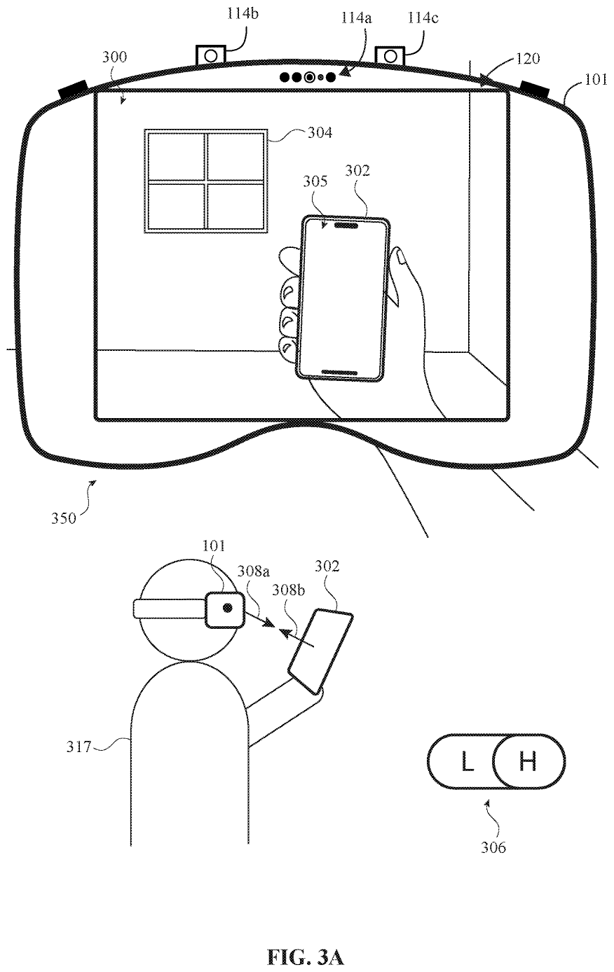

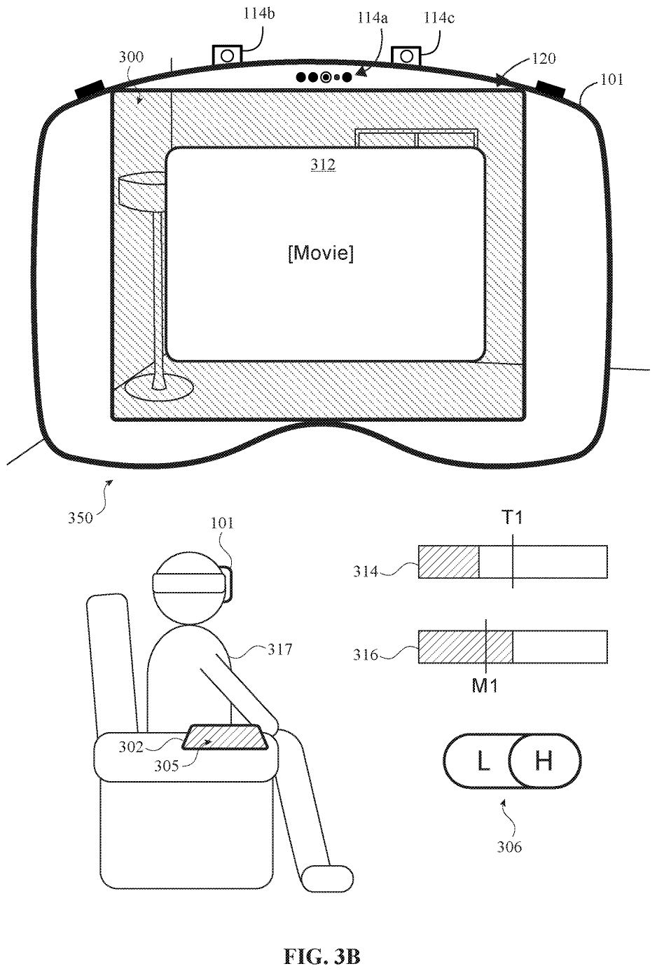

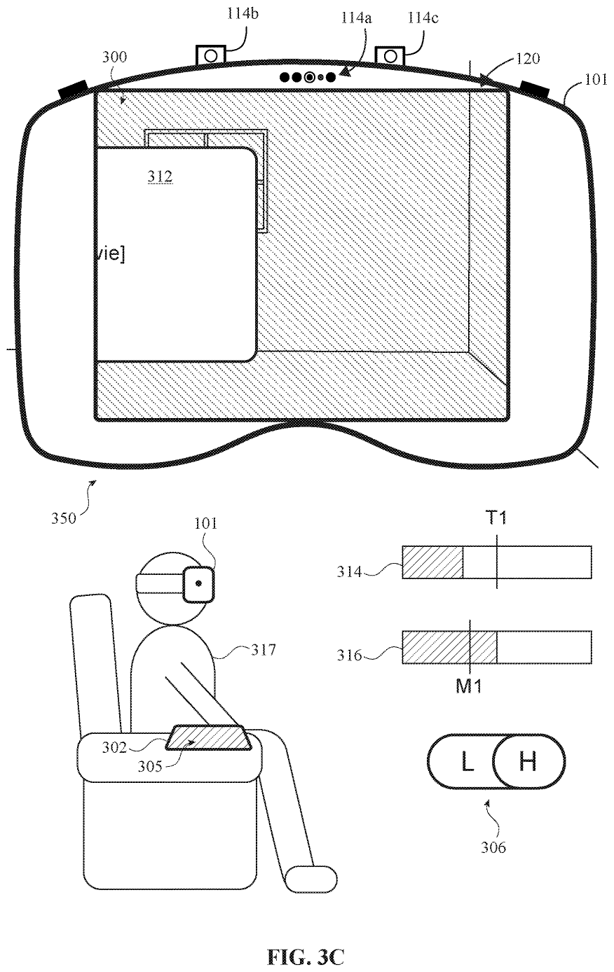

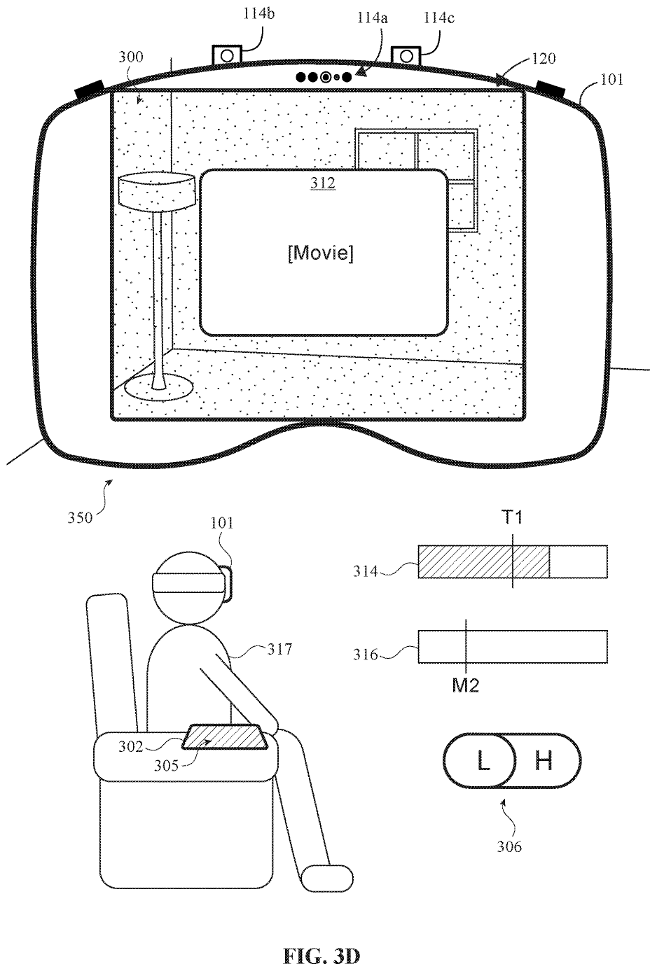

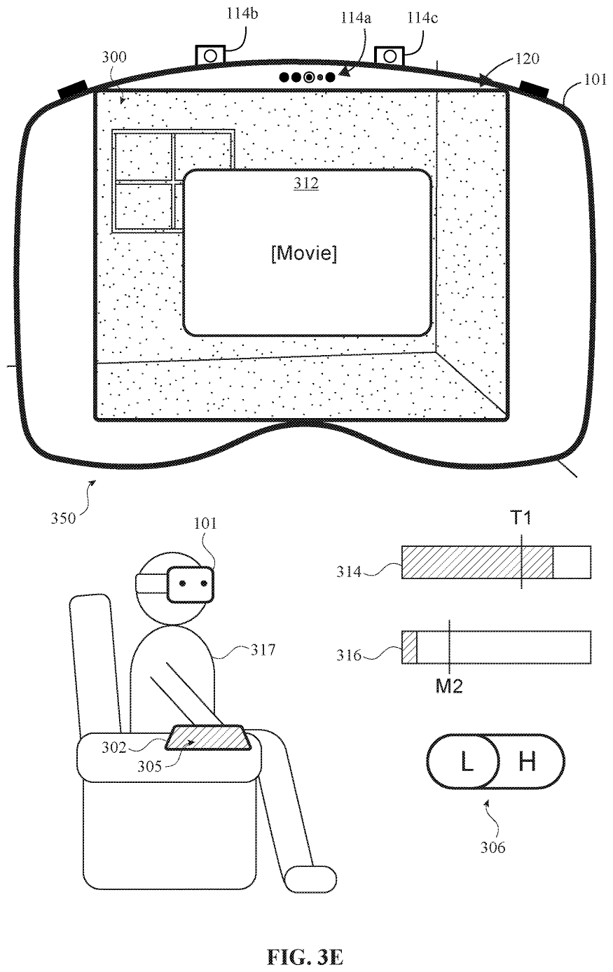

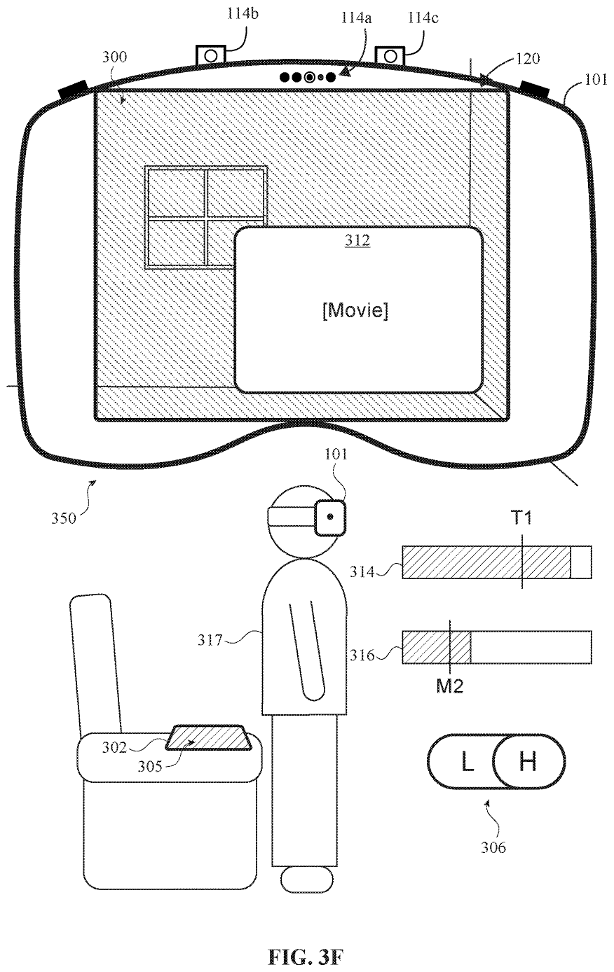

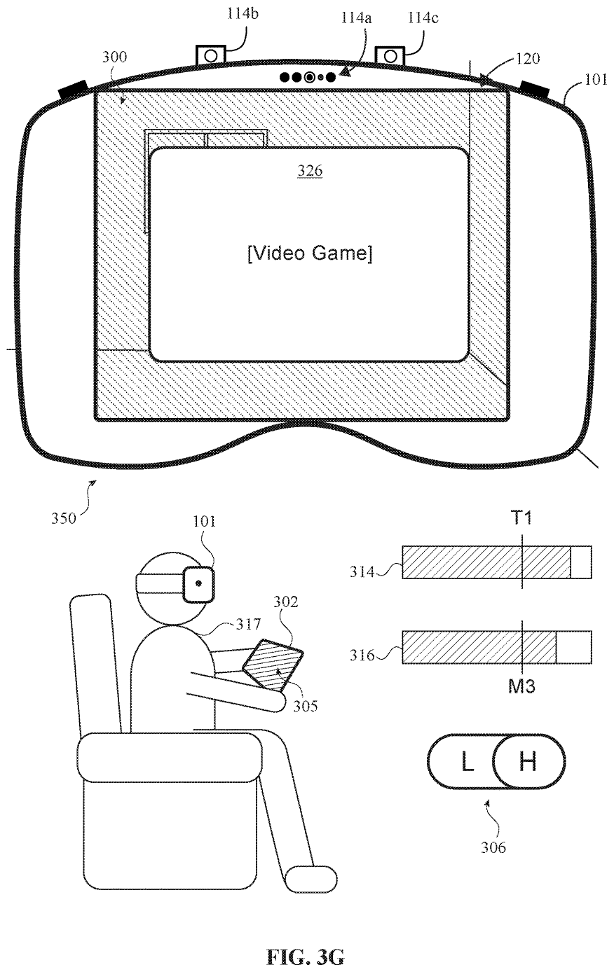

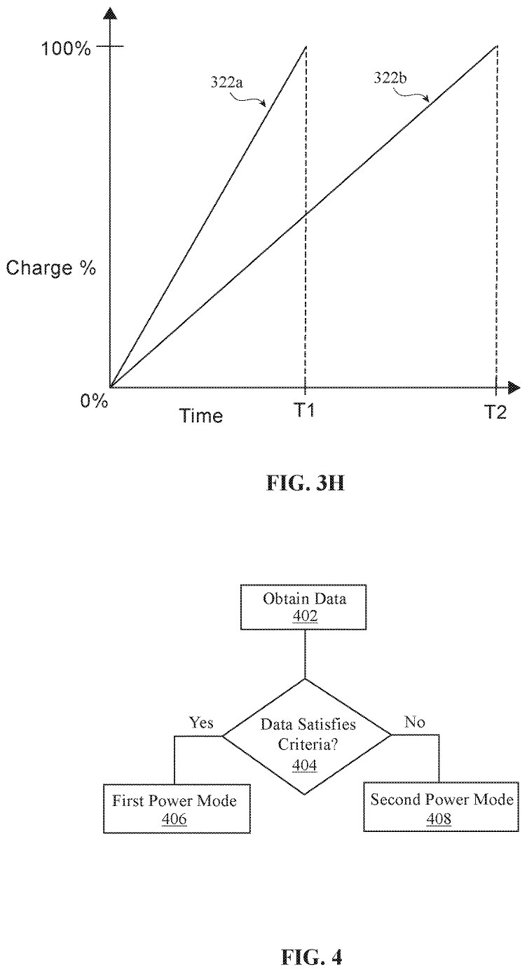

FIGS. 3A-3H illustrate an example where an electronic device transitions between different power states based on information gathered from one or more input devices according to some examples of the disclosure. FIGS. 3A-3H are used to illustrate the processes described below, including process 400, shown in FIG. 4.

FIG. 3A illustrates an electronic device 101 (e.g., corresponding to electronic device 270 presenting, via the display 120, a three-dimensional environment 300 including a portion of a physical environment 350 from a point of view of the user 317 of the electronic device 101. In FIG. 3A, the electronic device 101 optionally presents three-dimensional environment 300 via a video pass-through or optical see-through display. FIG. 3A shows a user 317 of the electronic device 101 holding an electronic device 302 (e.g., a companion device such as electronic device 160 and/or 260). The electronic device 302 causes the electronic device 101 to display the three-dimensional environment 300. For example, the electronic device 101 does not include a processor and/or other hardware for processing or generating content and the electronic device 101 is merely a display (e.g., display 120). Additionally, in some examples, the electronic device 302 causes the electronic device 101 to display content on display 120.

In some examples, a viewpoint of a user influences what content (e.g., physical and/or virtual objects) is visible in a viewport (e.g., a view of the physical environment 350 visible to the user via one or more displays 120, a display, or a pair of display modules that provide stereoscopic content to different eyes of the same user). In some examples, the (virtual) viewport has a viewport boundary that defines an extent of the physical environment 350 that is visible to the user via the display 120 in FIGS. 3A-3H. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head mounted device or moving with a hand of a user for a handheld device such as a tablet or smartphone). A viewpoint of a user influences what content is visible in the viewport, a viewpoint generally specifies a location and a direction relative to the physical environment 350, and as the viewpoint shifts, the view of the physical environment 350 will also shift in the viewport. For a head mounted device, a viewpoint is typically based on a location and a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays which typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see-through, portions of the physical environment that are visible (e.g., optically visible through one or more partially or fully transparent portions of the display generation component) via the one or more displays are based on a field of view of a user through the partially or fully transparent portions of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 3A, the electronic device 302 is in communication with electronic device 101. For example, electronic device 101 and electronic device 302 are in wireless (e.g., Bluetooth, Wi-Fi, and/or wireless network) communication or in a wired (e.g., via wires and/or cables, such as universal serial bus type A (USB-A), universal serial bus type C (USB-C), and/or ethernet) communication. In some examples, electronic device 101 and electronic device 302 share a common user account and/or a user (e.g., a common user/account uses the devices). For example, a user is optionally logged into one or more electronic devices using one user account (e.g., one username and password).

In some examples, the one or more electronic device 101 and/or electronic device 302 respectively include one or more sensors and/or one or more displays. For example, the electronic device(s) may include accelerometers, global positioning sensors (GPS), image sensors (image sensors 206A and/or 206B), orientation sensors (e.g., orientation sensors 210A and/or 210B), and/or location sensors (e.g., location sensors 204A and/or 204B). In some examples, while in the first power state, the electronic device 101 does not include a powered-on display, as shown in FIG. 3A. For example, in FIG. 3A, the electronic device 101 does not display content using display 120 and, instead, presents pass-through of the physical environment 350.

FIG. 3A illustrates an example where the user 317 is looking at electronic device 302 while wearing electronic device 101 (or while using electronic device 101). In FIG. 3A, indicator 306 indicates that the electronic device 302 is in the high power state. It should be understood that the indicator 306 is not necessarily a user interface element that is displayed and/or visible to the user 317 via the electronic device 101 and/or the electronic device 302, and is merely illustrative of the current power state or mode of the electronic device 302. In some examples, the electronic device 302 obtains data indicating that the user 317 is looking at the electronic device 302 based on orientation data from the electronic device 302 and/or electronic device 101. As described above, the electronic device 302 and the electronic device 101 include image sensors 206A, 206B, respectively, to detect orientation of the respective devices. As shown in FIG. 3A, the orientation data indicates that the orientation vector 308a of the electronic device 101 is opposite/opposing and parallel to the orientation vector 308b of electronic device 302. In some examples, the electronic device 302 determines that the electronic device 101 and the electronic device 302 are oriented towards (e.g., facing each other) when the orientation vectors 308a/308b are within a threshold angle of being parallel (e.g., ±1°, ±5°, ±10°, or ±30°), and/or when the orientation vectors 308a/308b are within parallel to each other within a threshold distance (e.g., 0.1 cm, 1 cm, 10 cm, or 15 cm). In some examples, if the electronic device 302 detects that the electronic device 101 and the electronic device 302 are facing each other using one or more sensors, the electronic device 302 may also activate one or more image sensors of electronic device 302 and/or electronic device 101 (e.g., outward facing cameras of electronic device 101, such as image sensors 114b and 114c, or a front facing camera of electronic device 302) to capture an image to confirm the that the electronic device 302 is facing the electronic device 101 and/or that the user 317 is looking at the electronic device 302. In some examples, the one or more image sensors 114b and 114c (e.g., outward facing camera of electronic device 101) capture a display state of electronic device 302 to determine whether the display 305 is on or off. In some examples, if the display 305 is on, then the electronic device 302 is determined to be in a high power state.

After confirming (or while confirming) that the user 307 is looking at the electronic device 302 (e.g., through electronic device 101), as shown in FIG. 3A, the electronic device 302 is confirmed to be operating in the high power state. For example, the electronic device activates and/or transitions to operating in the high power state in accordance with a determination that one or more first criteria are satisfied. In some examples, the one or more first criteria to activate the high power state include a criterion that is satisfied when the user 317 is looking at and/or using electronic device 302. While in the high power state, the electronic device 302 turns on the associated display, such as display 305. In some examples, powering the display 305 of the electronic device 302 is a power intensive task, so the electronic device 302 activates the display 305 in accordance with the determination that the user 317 is actually looking at the display 305. In FIG. 3A, the electronic device 302 determines that the user 307 is looking at the electronic device 302, which satisfies the one or more first criteria above, and therefore the electronic device 302 activates the display 305 (e.g., at a first brightness). In some examples, the electronic device 302 turns on the display 305 in response to detecting a physical input directed towards the electronic device 302. For example, the electronic device 302 detects an input directed towards a power button of electronic device 302 to turn on the display 305 or a touch input directed to the display 305 (e.g., a tap of a finger on the display 305) provided by the user 317.

FIG. 3B illustrates a different example of the electronic device 302 operating in a high power state. In some examples, the one or more first criteria for activating the high power state includes a criterion that is satisfied when the electronic device 302 determines that the display 120 is active while the display 305 is inactive and/or is powered off. In some examples, the electronic device 302 obtains a display state of the electronic device 101 and the electronic device 302. In FIG. 3B, the electronic device 302 has caused the electronic device 101 to display a movie (or other media content) in a movie user interface 312 of a movie application (e.g., the display 120 is on/active). In some examples, the electronic device 302 causes the electronic device 101 to display the movie user interface 312 in an immersive view or mode. For example, in FIG. 3B, the electronic device 101 displays the movie user interface 312 while the representation of the physical environment 350 is deemphasized (e.g., the view of physical environment 350 is displayed with shading or is presented with a dimming effect) relative to the movie user interface 312 in the three-dimensional environment 300. While viewing the movie user interface 312, the display 305 of electronic device 302 has a second brightness, lower than the first brightness shown in FIG. 3A. In some examples, in FIG. 3B, the electronic device 302 uses one or more input devices (e.g., the sensors of electronic device 101 and/or electronic device 302) in a manner as similarly discussed above to determine that the user 317 is not looking at the electronic device 302. While the user 317 is not using and/or looking at electronic device 302, the electronic device 302 turns off display 305 and/or uses a second brightness level for display 305. In some examples, the user 317 has manually turned off the display 305 using one or more input devices (e.g., by pressing a power button on the electronic device 302). Additionally, as shown in the side view in FIG. 3B, the user 317 is facing a first direction while viewing the movie user interface 312 in the three-dimensional environment 300.

In some examples, the one or more first criteria include a criterion that is satisfied when content is displayed via the electronic device 101 by the electronic device 302 for less than a threshold amount of time. For example, in FIG. 3B, while causing the electronic device 101 to present movie user interface 312, the electronic device 302 has not met the threshold amount of time (e.g., indicated by indicator 314) where the electronic device 302 would transition from the high power mode to the low power mode. In some examples, the time threshold is 5 seconds, 30 seconds, 1 minute, 5 minutes, or 10 minutes. In some examples, the one or more first criteria include a criterion that is satisfied when the electronic device 302 and/or the electronic device 101 detect movement of the electronic device 101 that is above a threshold movement. For example, the electronic device 302 transitions from the high power mode to a low power mode while displaying a user interface (e.g., user interface 312) after detecting that the user has been relatively still for the threshold amount of time (e.g., movement under a threshold movement for the threshold amount of time above). In some examples, the movement threshold is a threshold where the electronic device 302 and/or electronic device 101 does not detect a movement that causes over 0.1 m/s\hat{ }, 0.5 m/s\hat{ }, or 1 m/s\hat{ } of acceleration. For example, the electronic device 302 and/or electronic device 101 use the one or more orientation sensor(s) 210A, 210B to determine acceleration of electronic device 101. FIG. 3B includes indicator 316 including an indication of the movement threshold M1. In FIG. 3B, the user's movements (e.g., the movement of electronic device 101) exceeds the threshold movement M1, thereby satisfying the one or more first criteria discussed above, so the electronic device 302 forgoes transitioning from the high power mode to the low power mode (e.g., continues operating according to the high power mode, as illustrated by indication 306).

FIG. 3C illustrates that the electronic device 302 is still in a high power mode after the electronic device 302 detects movement of the electronic device 101 greater than the threshold movement, M1, while the user is viewing user interface 312. In FIG. 3C, the electronic device 302 and/or electronic device 101 detect that the user 317 has moved electronic device 101 (e.g., by moving/rotating their head). For example, as illustrated in the side view in FIG. 3C, the user 317 is facing a second direction, different from the first direction in FIG. 3B, while viewing the movie user interface 312 in the three-dimensional environment 300. Because the movement occurred before the threshold time T1 (e.g., which continues to satisfy the one or more first criteria discussed above), the electronic device 101 continues to be in the high power mode. While in the high power mode, the electronic device 302 performs body locking (e.g., displays the movie user interface 312 in a body locked orientation), which is described in greater detail above. Because the electronic device 302 is performing body locking, the user interface 312 is not moved in the three-dimensional environment 300 when the electronic device 101 is moved (e.g., the electronic device 302 maintains display of the movie user interface 312 at its same position and/or orientation relative to the torso of the user 317). Performing body locking improves user-device interaction by providing a more comfortable viewing environment while the user is moving (e.g., not remaining still). Additionally, and as described above, while in the high power mode, the electronic device 302 displays the movie user interface 312 at a first content refresh rate and/or a first render rate. Because the electronic device 302 is performing body locking on the movie user interface 312 displayed via the electronic device 101, the electronic device 302 has a high content refresh rate and/or high render rate to adjust the display of the content based on the user's movements.

In FIG. 3D, the electronic device 302 transitions to the low power mode after detecting the threshold amount of time has elapsed without detecting movement of the electronic device 101 above the threshold movement M1. For example, as shown by the indicator 314 in FIG. 3D, the time has exceeded the time threshold T1 while the electronic device 302 does not detect a movement greater than the movement threshold M1, as indicated by the indicator 316.

In some examples, the electronic device 302 transitions from operating in the low power mode to operating in the high power mode in accordance with a determination that one or more second criteria are satisfied. In some examples, the one or more second criteria include a criterion that is satisfied when the electronic device 302 and/or the electronic device 101 detect movement of the electronic device 101 above a second movement threshold. In some examples, as illustrated in indicator 316, the second movement threshold M2 is a lower threshold than the movement threshold M1 discussed above with reference to FIG. 3B. For example, the movement threshold to transition from the low power mode to the high power mode is lower than the movement threshold to transition from the high power mode to the low power mode. In other words, less confidence is required to transition from the low power mode to the high power mode. In some examples, the movement threshold M2 is a movement over 0.1 m/s\hat{ }, 0.5 m/s\hat{ }, or 1 m/s\hat{ } of acceleration. In FIG. 3D, the electronic device 302 and/or the electronic device 101 determine that the movement of the electronic device 101 is below the movement threshold M2; accordingly, the electronic device 302 is operating in the low power mode, as illustrated via the indicator 306.

While in the low power mode, the electronic device 302 performs a second set of power functions, such as head locking and/or displaying content at a second content refresh rate lower than the content refresh rate of the high power mode and/or a second render rate lower than the render rate of the high power mode. The low power mode is described in greater detail above.

In some examples, while in the low power mode, the electronic device 302 displays content, such as user interface 312 at a smaller size (e.g., as shown in FIG. 3D) than the content displayed while in the high power mode, such as user interface 312 shown in FIG. 3C. In some examples, while in the low power mode, the electronic device 302 displays content in a less power intensive way. For example, the electronic device 302 scales down the display of the content from a full immersive mode (e.g., as shown in FIG. 3C), to a two-dimensional window (e.g., as shown in FIG. 3D). As shown in FIG. 3D, there is less contrast (e.g., as indicated by the shading) between the user interface 312 and the representation of the physical environment 350 than shown in FIG. 3C.

In some examples, while displaying content in a low power mode, as shown in FIG. 3D, the electronic device 302 transitions from displaying content in a body locking mode to a head locking mode. Body locking and head locking are described in greater detail above. While in a head locking mode, the electronic device 302 uses less power because the electronic device 302 displays content according to a lower rendering and/or content refresh rate, and because electronic device 302 displays content in the same region of display 120, irrespective of the user's head and/or body pose. For example, while in the head locking mode, the electronic device 302 updates display of the content with less frequency than in the body locking mode, as the content remains stationary within display 120 while in the head locking mode.

In some examples, while in the low power mode, the electronic device 302 causes the display (e.g., display 305 above) of electronic device 302 to be at a second brightness level lower than the brightness level of the electronic device 302 in the high power mode. Alternatively, in some examples, the electronic device 302 causes the display of electronic device 302 to be at a brightness level higher than the brightness level of the display of the electronic device 302 in the high power mode. In some examples, the electronic device 302 performs the set of power functions described in reference to the low power mode independently or in conjunction.

In FIG. 3E, the electronic device 302 updates the content displayed on electronic device 101 in response to detecting a movement of electronic device 101 that satisfies the one or more second criteria discussed above. Particularly, in FIG. 3E, the user 317 moves their head slightly (e.g., the movement is under the threshold movement, M2, as shown by indicator 316). In response to detecting the movement, the electronic device 302 optionally updates electronic device 101 to illustrate a change in a visual appearance of the passthrough or see through portions surrounding the user interface 312 (e.g., the representation of the physical environment 350). Because the electronic device 302 is in a low power mode, the electronic device 302 performs head-locking (e.g., the electronic device 302 displays the user interface 312 in a head locked orientation), such that the user interface 312 moves as the electronic device 101 moves. As shown in FIG. 3E, the user interface 312 continues to be displayed in the center of the display 120 when the electronic device 101 is moved in the physical environment in accordance with the movement of the head of the user 317. Additionally, in FIG. 3E, the movement of the electronic device 101 does not exceed the movement threshold, M2 (e.g., the movement of the electronic device 101 does not satisfy the one or more second criteria discussed above), so the electronic device 302 does not transition (e.g., forgoes transitioning) from the low power mode to the high power mode.

In FIG. 3F, the electronic device 302 detects a movement of electronic device 101 that exceeds the movement threshold, M2. For example, in FIG. 3F, the user 317 stands up, which causes the electronic device 301 to be moved (e.g., vertically) in the physical environment. In response to detecting the movement that exceeds the movement threshold M2 (e.g., that satisfies the one or more second criteria discussed above), the electronic device 302 transitions from the low power mode to the high power mode, as illustrated in indication 306, and performs the one or more power functions of the high power mode, as described above. For example, as shown in FIG. 3F, the electronic device 302 performs body locking on the electronic device 101 (e.g., displays the user interface 312 in a body locked orientation), such that the user interface 312 continues to be displayed at the same location and/or orientation in the three-dimensional environment 300 relative to the torso of the user 317, as shown in FIG. 3E, as the viewpoint of the user 317 changes in FIG. 3F. Additionally, in FIG. 3F, the electronic device 302 causes the electronic device 101 to display the content in a more immersive mode (e.g., at a larger size and/or with a more distinct change in brightness between the user interface 312 and the representation of the physical environment 350). Additionally, in FIG. 3F, the electronic device 302 increases the render rate, content refresh rate, and/or frame rate. Additionally, the electronic device 302 optionally reduces the reprojection rate. In some examples, the electronic device 302 reduces a persistence of the content displayed via the electronic device 101.

In FIG. 3F, the electronic device 302 continues to maintain the lower brightness for the display (e.g., display 305) of electronic device 302 even though the electronic device 302 is operating at the high power mode. In some examples, and as described above, the electronic device 302 may perform one or more of the power functions associated with the high power mode (or low power mode). In some examples, in FIG. 3F, the electronic device 302 detects that the user 317 is not looking at the electronic device 302 (as described in greater detail above), and therefore, the electronic device 302 does not change the brightness of the display of electronic device 302.

FIG. 3G illustrates a different example of the electronic device 302 operating in a high power mode while the electronic device 101 displays a user interface 326 of a video game application. In some examples, the one or more first criteria to activate the high power mode includes detecting that a video game application is active on the electronic device 101 and/or the electronic device 302 (e.g., while or after other applications are running on the electronic device 302). After detecting or while detecting that a video game application is active, the electronic device 302 transitions from a low power mode to a high power mode and/or remains in the high power mode, as indicated by indication 306 in FIG. 3G. While a video game application is running on the electronic device 302 and/or the electronic device 101, the electronic device 101 may move more frequently since the user is actively participating in a video game. In some examples, while a video game application is running on the electronic device 302 and/or the electronic device 101, a (e.g., third) movement threshold is established for transitioning operation of the electronic device 302 between power modes. For example, in FIG. 3G, third movement threshold, M3, illustrated in indicator 318, is higher than the movement threshold, M1, shown in FIG. 3B. Specifically, in some examples, because electronic device 101 and/or electronic device 302 move more while a user 317 is using a video game application, the movement threshold to transition from the high power mode to the low power mode (or from the low power mode to the high power mode) is higher. Additionally, in some examples, the corresponding threshold movement for transitioning from the low power mode to the high power mode while a user interface of a video game application is displayed on electronic device 101 is a higher threshold than the movement threshold, M2, shown in FIG. 3D.

Additionally, in FIG. 3G, both electronic device 101 and electronic device 302 are in use by the user 317 while interacting with the video game application. However, because the electronic device 302 and/or the electronic device 101 are not facing each other (e.g., determined using the one or more first criteria described above with reference to FIG. 3A), the electronic device 302 does not increase (e.g., forgoes increasing) the display brightness of the display (e.g., display 305) of electronic device 302.

FIG. 3H illustrates a graph indicating the charge percentage of electronic device 302 while the electronic device 302 is in active communication with electronic device 101 and while the electronic device 302 is not actively in communication with electronic device 101. In some examples, being actively in communication includes actively displaying content on electronic device 101, such as actively displaying user interface 312 in FIG. 3F or user interface 326 in FIG. 3G. In some examples, while the electronic device 302 is plugged in and charging and is also actively in communication with electronic device 101, the electronic device 302 modulates (e.g., decreases) its charging speed (e.g., indicated by line 322b, in FIG. 3H) to prevent overheating of one or more components of electronic device 302. In some examples, while the electronic device 302 is plugged in and charging but is not actively in communication with electronic device 101, the electronic device 302 forgoes modulating its charging speed (e.g., or modulates its charging speed at a lower rate), allowing the electronic device 302 to charge faster (e.g., indicated by line 322a, in FIG. 3H). In some examples, the electronic device 302 modulates charging speeds to perform thermal mitigation for the electronic device 302.

It is understood that the examples shown and described herein are merely exemplary and that additional and/or alternative elements may be provided within the three-dimensional environment for modulating power consumption while using the electronic device. It should be understood that the appearance, shape, form, and size of each of the various user interface elements and objects shown and described herein are exemplary and that alternative appearances, shapes, forms and/or sizes may be provided. For example, the virtual objects representative of user interfaces (e.g., user interface 312) may be provided in alternative shapes than those shown, such as a rectangular shape, circular shape, triangular shape, etc. Additionally or alternatively, in some examples, the various options, user interface elements, control elements, etc. described herein may be selected and/or manipulated via user input received via one or more input devices in communication with the electronic device (or electronic devices). For example, selection input may be received via physical input devices, such as a mouse, trackpad, keyboard, etc. in communication with the electronic devices (or electronic devices), or a physical button integrated with the electronic devices (or electronic devices).

FIG. 4 illustrates a flow diagram illustrating an example process for transitioning between different power states based on information gathered from one or more input devices according to some examples of the disclosure. In some examples, process 400 begins at an electronic device in communication with one or more first displays, one or more second displays, and one or more input devices. In some examples, the electronic device is optionally a head-mounted display similar or corresponding to electronic device 201 of FIG. 2A or a mobile electronic device similar or corresponding to electronic device 260 of FIG. 2B. In some examples, the one or more first displays are displays of the mobile electronic device (e.g., a companion device) and the one or more second displays include a head mounted display (e.g., similar or corresponding to electronic device 201 of FIG. 2A). As shown in FIG. 4, in some examples, at 402, the electronic device obtains data via the one or more input devices. For example, the electronic device 302, shown in FIG. 3A, obtains data relating to the context of the electronic device 302 and/or of electronic device 101, also shown in FIG. 3A.

As shown in FIG. 4, in some examples, at 404, the electronic device determines if the data obtained satisfies one or more criteria. In some examples, the one or more criteria include and/or corresponds to the one or more first criteria and/or the one or more second criteria described in FIGS. 3A-3G. For example, the one or more criteria include a criterion that is satisfied when the orientation of the electronic device 302 and the orientation of the electronic device 101 are aligned, a criterion that is satisfied when the displays of electronic device 302 are off but the displays of electronic device 101 are on, a criterion that is satisfied when the user is looking at the displays of electronic device 101, and/or a criterion that is satisfied when the electronic device 302 detects a movement above a threshold movement.

In some examples, if the one or more criteria are satisfied, then, at step 406, the electronic device 302 is in a first power mode (e.g., a high power mode). In some examples, if the one or more criteria are not satisfied, then, at step 408, the electronic device 302 is in a second power mode (e.g., a low power mode). In some examples, the high power mode is shown and described in FIGS. 3B, 3C, 3F, and 3G. In some examples, the low power mode is shown and described in FIGS. 3D and 3E.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method, comprising at an electronic device in communication with one or more first displays, one or more second displays, and one or more input devices: obtaining data via the one or more input devices; and in accordance with a determination that one or more first criteria are satisfied, the one or more first criteria including a criterion that is satisfied based on the data obtained via the one or more input devices, performing a first set of power functions including a function to cause the one or more second displays to display content in a first manner; and in accordance with a determination that the one or more first criteria are not satisfied, performing a second set of power functions, different from the first set of power functions, including a function to cause the one or more second displays to display content in a second manner, different from the first manner. Additionally or alternatively to one of more of the examples disclosed above, in some examples, obtaining the data includes: obtaining first data indicating a first orientation of the electronic device relative to an environment of the electronic device; and obtaining second data indicating a second orientation of the one or more second displays relative to the environment using the one or more input devices. Additionally or alternatively to one of more of the examples disclosed above, in some examples, obtaining the data further includes determining a first vector corresponding to the first orientation and determining a second vector corresponding to the second orientation; and the one or more first criteria include a criterion that is satisfied when the first vector is not aligned with the second vector. Additionally or alternatively to one of more of the examples disclosed above, in some examples, obtaining the data includes obtaining first data indicating a first display state of the one or more first displays and second data indicating a second display state of the one or more second displays; and the one or more first criteria include a criterion that is satisfied when the first display state indicates the one or more first displays is powered off and the second display state indicates the one or more second displays are powered on. Additionally or alternatively to one of more of the examples disclosed above, in some examples, obtaining the data includes obtaining a second display state of the one or more second displays using the one or more input devices in communication with the electronic device; and the one or more first criteria include a criterion that is satisfied when the second display state indicates that the one or more second displays are powered on while the one or more second displays are in view of the one or more input devices. Additionally or alternatively to one of more of the examples disclosed above, in some examples, the one or more first criteria include: a first criterion that is satisfied when the electronic device detects, via the one or more input devices, a movement of a user of the electronic device above a threshold movement; and a second criterion that is satisfied when a first application is currently active on the electronic device. Additionally or alternatively to one of more of the examples disclosed above, in some examples, the first set of power functions includes at least one of a world locking mode, body locking mode, a face tracking mode, a first content refresh rate, or a first render rate. Additionally or alternatively to one of more of the examples disclosed above, in some examples, the second set of power functions includes at least one of a head locking mode, a second content refresh rate that is different from the first content refresh rate, or a second render rate that is different from the first render rate. Additionally or alternatively to one of more of the examples disclosed above, in some examples, the first set of power functions includes a first render rate and a first content refresh rate, and the second set of power functions includes a second render rate that is lower than the first render rate and the first content refresh rate. Additionally or alternatively to one of more of the examples disclosed above, in some examples, the first set of power functions includes displaying, via the one or more second displays, content at a first size, and the second set of power functions includes displaying the content at a second size, smaller than the first size. Additionally or alternatively to one of more of the examples disclosed above, in some examples, performing the second set of power functions includes performing a plurality of actions on the electronic device including: lowering a brightness associated with the one or more first displays; reducing a frame rate of content displayed via the one or more first displays; increasing a persistence of the content displayed via the one or more first displays; and/or maintaining a reprojection rate of the one or more second displays above a threshold reprojection rate. Additionally or alternatively to one of more of the examples disclosed above, in some examples, while performing the second set of power functions in accordance with the determination that the one or more first criteria are not satisfied: in accordance with a determination that one or more second criteria are satisfied, ceasing performing the second set of power functions and performing the first set of power functions; and in accordance with a determination that one or more second criteria are not satisfied, continuing performing the second set of power functions. Additionally or alternatively to one of more of the examples disclosed above, in some examples, the one or more second criteria include a criterion that is satisfied when the electronic device detects, via the one or more input devices, a movement of the electronic device greater than a threshold movement. Additionally or alternatively to one of more of the examples disclosed above, in some examples, the threshold movement is lower than a respective threshold movement of the electronic device that satisfies the one or more first criteria. Additionally or alternatively to one of more of the examples disclosed above, in some examples, obtaining the data includes obtaining charging data, and the method further comprises: in accordance with a determination that the charging data includes an indication that the electronic device is actively in communication with the one or more second displays, modulating a charging speed; and in accordance with a determination that the charging data does not include the indication, forging modulating the charging speed. Additionally or alternatively to one of more of the examples disclosed above, in some examples, the one or more second displays include a head-mounted display.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more first displays, one or more second displays, and one or more input devices:
obtaining data via the one or more input devices; and
in accordance with a determination that one or more first criteria are satisfied, the one or more first criteria including a criterion that is satisfied based on the data obtained via the one or more input devices, performing a first set of power functions including a function to cause the one or more second displays to display content in a first manner; and
in accordance with a determination that the one or more first criteria are not satisfied, performing a second set of power functions, different from the first set of power functions, including a function to cause the one or more second displays to display content in a second manner, different from the first manner.

2. The method of claim 1, wherein obtaining the data includes:
obtaining first data indicating a first orientation of the electronic device relative to an environment of the electronic device; and
obtaining second data indicating a second orientation of the one or more second displays relative to the environment using the one or more input devices.

3. The method of claim 1, wherein:
obtaining the data includes obtaining first data indicating a first display state of the one or more first displays and second data indicating a second display state of the one or more second displays; and
the one or more first criteria include a criterion that is satisfied when the first display state indicates the one or more first displays is powered off and the second display state indicates the one or more second displays are powered on.

4. The method of claim 1, wherein:
obtaining the data includes obtaining a second display state of the one or more second displays using the one or more input devices in communication with the electronic device; and
the one or more first criteria include a criterion that is satisfied when the second display state indicates that the one or more second displays are powered on while the one or more second displays are in view of the one or more input devices.

5. The method of claim 1, wherein the one or more first criteria include:
a first criterion that is satisfied when the electronic device detects, via the one or more input devices, a movement of a user of the electronic device above a threshold movement; and
a second criterion that is satisfied when a first application is currently active on the electronic device.

6. The method of claim 1, wherein:
the first set of power functions includes at least one of a world locking mode, body locking mode, a face tracking mode, a first content refresh rate, or a first render rate; and
the second set of power functions includes at least one of a head locking mode, a second content refresh rate that is different from the first content refresh rate, or a second render rate that is different from the first render rate.

7. The method of claim 1, wherein performing the second set of power functions includes performing a plurality of actions on the electronic device including:
lowering a brightness associated with the one or more first displays;
reducing a frame rate of content displayed via the one or more first displays;
increasing a persistence of the content displayed via the one or more first displays; and/or maintaining a reprojection rate of the one or more second displays above a threshold reprojection rate.

8. The method of claim 1, wherein obtaining the data includes obtaining charging data, and the method further comprises:
in accordance with a determination that the charging data includes an indication that the electronic device is actively in communication with the one or more second displays, modulating a charging speed; and
in accordance with a determination that the charging data does not include the indication, forging modulating the charging speed.

9. An electronic device in communication with one or more first displays, one or more second displays, and one or more input devices comprising:
a memory;
one or more processors; and
one or more programs stored in the memory and configured to be executed by the one or more processors, the one or more programs including instructions for:
obtaining data via the one or more input devices; and
in accordance with a determination that one or more first criteria are satisfied, the one or more first criteria including a criterion that is satisfied based on the data obtained via the one or more input devices, performing a first set of power functions including a function to cause the one or more second displays to display content in a first manner; and
in accordance with a determination that the one or more first criteria are not satisfied, performing a second set of power functions, different from the first set of power functions, including a function to cause the one or more second displays to display content in a second manner, different from the first manner.

10. The electronic device of claim 9, wherein obtaining the data includes:
obtaining first data indicating a first orientation of the electronic device relative to an environment of the electronic device; and
obtaining second data indicating a second orientation of the one or more second displays relative to the environment using the one or more input devices.

11. The electronic device of claim 9, wherein:
obtaining the data includes obtaining first data indicating a first display state of the one or more first displays and second data indicating a second display state of the one or more second displays; and
the one or more first criteria include a criterion that is satisfied when the first display state indicates the one or more first displays is powered off and the second display state indicates the one or more second displays are powered on.

12. The electronic device of claim 9, wherein:
obtaining the data includes obtaining a second display state of the one or more second displays using the one or more input devices in communication with the electronic device; and
the one or more first criteria include a criterion that is satisfied when the second display state indicates that the one or more second displays are powered on while the one or more second displays are in view of the one or more input devices.

13. The electronic device of claim 9, wherein the one or more first criteria include:
a first criterion that is satisfied when the electronic device detects, via the one or more input devices, a movement of a user of the electronic device above a threshold movement; and
a second criterion that is satisfied when a first application is currently active on the electronic device.

14. The electronic device of claim 9, wherein:
the first set of power functions includes at least one of a world locking mode, body locking mode, a face tracking mode, a first content refresh rate, or a first render rate; and
the second set of power functions includes at least one of a head locking mode, a second content refresh rate that is different from the first content refresh rate, or a second render rate that is different from the first render rate.

15. The electronic device of claim 9, wherein performing the second set of power functions includes performing a plurality of actions on the electronic device including:
lowering a brightness associated with the one or more first displays;
reducing a frame rate of content displayed via the one or more first displays;
increasing a persistence of the content displayed via the one or more first displays; and/or maintaining a reprojection rate of the one or more second displays above a threshold reprojection rate.

16. The electronic device of claim 9, wherein obtaining the data includes obtaining charging data, and the one or more programs further including instructions for:
in accordance with a determination that the charging data includes an indication that the electronic device is actively in communication with the one or more second displays, modulating a charging speed; and
in accordance with a determination that the charging data does not include the indication, forging modulating the charging speed.

17. A non-transitory computer readable storage medium storing one or more programs, the one or more programs comprising instructions, which when executed by one or more processors of an electronic device, cause the electronic device to:
obtain data via one or more input devices; and
in accordance with a determination that one or more first criteria are satisfied, the one or more first criteria including a criterion that is satisfied based on the data obtained via the one or more input devices, perform a first set of power functions including a function to cause one or more second displays to display content in a first manner; and
in accordance with a determination that the one or more first criteria are not satisfied, perform a second set of power functions, different from the first set of power functions, including a function to cause the one or more second displays to display content in a second manner, different from the first manner.

18. The non-transitory computer readable storage medium of claim 17, wherein obtaining the data includes:
obtaining first data indicating a first orientation of the electronic device relative to an environment of the electronic device; and
obtaining second data indicating a second orientation of the one or more second displays relative to the environment using the one or more input devices.

19. The non-transitory computer readable storage medium of claim 17, wherein:
obtaining the data includes obtaining first data indicating a first display state of the one or more first displays and second data indicating a second display state of the one or more second displays; and
the one or more first criteria include a criterion that is satisfied when the first display state indicates the one or more first displays is powered off and the second display state indicates the one or more second displays are powered on.

20. The non-transitory computer readable storage medium of claim 17, wherein:
obtaining the data includes obtaining a second display state of the one or more second displays using the one or more input devices in communication with the electronic device; and
the one or more first criteria include a criterion that is satisfied when the second display state indicates that the one or more second displays are powered on while the one or more second displays are in view of the one or more input devices.

21. The non-transitory computer readable storage medium of claim 17, wherein the one or more first criteria include:
a first criterion that is satisfied when the electronic device detects, via the one or more input devices, a movement of a user of the electronic device above a threshold movement; and
a second criterion that is satisfied when a first application is currently active on the electronic device.

22. The non-transitory computer readable storage medium of claim 17, wherein:
the first set of power functions includes at least one of a world locking mode, body locking mode, a face tracking mode, a first content refresh rate, or a first render rate; and
the second set of power functions includes at least one of a head locking mode, a second content refresh rate that is different from the first content refresh rate, or a second render rate that is different from the first render rate.

23. The non-transitory computer readable storage medium of claim 17, wherein performing the second set of power functions includes performing a plurality of actions on the electronic device including:
lowering a brightness associated with one or more first displays;
reducing a frame rate of content displayed via the one or more first displays;
increasing a persistence of the content displayed via the one or more first displays; and/or
maintaining a reprojection rate of the one or more second displays above a threshold reprojection rate.

24. The non-transitory computer readable storage medium of claim 17, wherein obtaining the data includes obtaining charging data, and the one or more programs further causes the electronic device to:
in accordance with a determination that the charging data includes an indication that the electronic device is actively in communication with the one or more second displays, modulate a charging speed; and
in accordance with a determination that the charging data does not include the indication, forgo modulating the charging speed.
